(19) United States
(12) Patent Application Publication
(10) Pub. No.: US 2015/0201104 A1
(43) Pub. Date: Jul. 16, 2015

(54) THREE-DIMENSIONAL IMAGE SEARCHING BASED ON INPUTS COLLECTED BY A MOBILE DEVICE

(71) Applicant: Imaginestics LLC, West Lafayette, IN (US)

(72) Inventors: Nainesh Rathod, West Lafayette, IN (US); Jamie Tan, West Lafayette, IN (US)

(21) Appl. No.: 14/153,918

(22) Filed: Jan. 13, 2014

(51) Int. Cl. H04N 1/21; G06F 17/30

(52) U.S. Cl. CPC H04N 1/2116; G06F 17/30274; G06F 17/30247

(57) ABSTRACT

A method of searching a database of component parts includes capturing a plurality of images of an object. The capturing is performed by use of a camera of a mobile electronic device. The images are captured from at least two different angles. The captured images are submitted as a group into a search engine. The database of component parts is searched by use of the search engine. A result of the searching is dependent upon each of the captured images in the group.

### BACKGROUND

### Field of the Invention

The present invention relates to computer search engines, and, more particularly, to computer search engines that enable a user to search based on visual features.

### SUMMARY OF THE INVENTION

The present invention provides a computer search engine system that uses multiple images captured by the camera of a mobile device as inputs in a search for a matching part in an image database.

The invention comprises, in one form thereof, a method of searching a database of component parts, including capturing a plurality of images of an object. The capturing is performed by use of a camera of a mobile electronic device. The images are captured from at least two different angles. The captured images are submitted as a group into a search engine. The database of component parts is searched by use of the search engine. A result of the searching is dependent upon each of the captured images of the group.

The invention comprises, in another form thereof, a method of searching a database of component parts, including capturing at least three images of an object. The capturing is performed by use of a camera of a mobile electronic device. Each of the images is captured from a different respective angle. The captured images are submitted into a search engine. The database of component parts is searched by use of the search engine. A result of the searching is dependent upon each of the captured images.

The invention comprises, in yet another form thereof, a method of searching a database of component parts, including capturing at least seven images of an object. The capturing is performed by use of a camera of a mobile electronic device. Each of the images is captured from a different respective angle. The captured images are submitted into a search engine. The database is searched, by use of the search engine, for a component part best matching the captured images. A result of the searching is dependent upon each of the captured images.

An advantage of the invention is that better and more accurate search results may be obtained due to the search being based on a greater number of input images.

Another advantage is that none of the images have to be captured at a right angle relative to each other.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a search engine arrangement of the present invention; and

FIG. 2 is a flow chart of one embodiment of a search method of the present invention.

Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

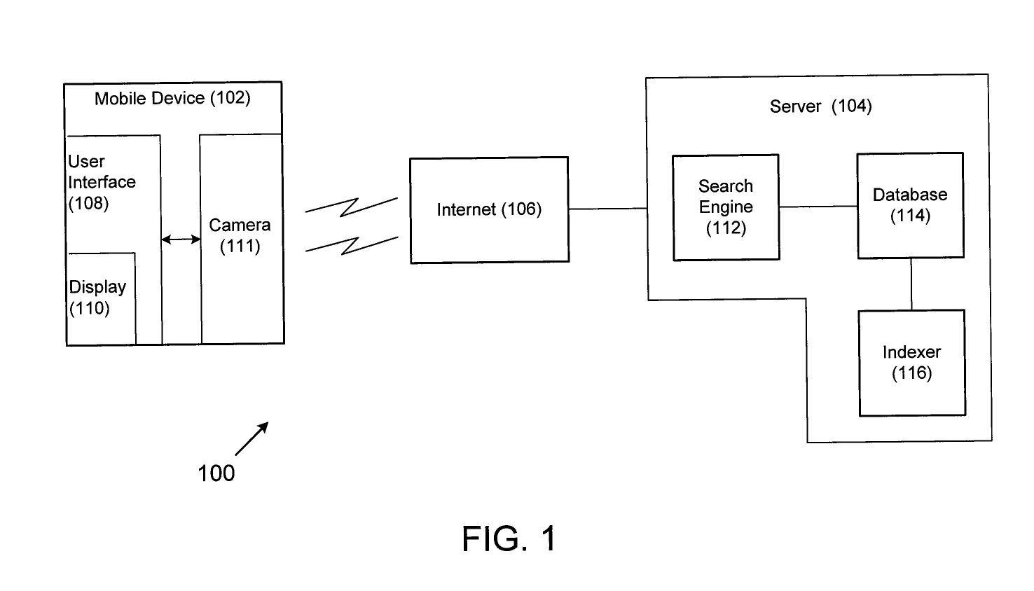

In one embodiment, the invention may be applied to a search engine that may search for images of two or more dimensions. One specific embodiment of a search engine arrangement 100 of the present invention is illustrated in FIG. 1. Arrangement 100 includes a mobile electronic telecommunication device 102 in communication with a server 104 via the Internet 106. Device 102 may be a smartphone, similar to those marketed by Samsung Electronics Co., Ltd. (e.g., Galaxy) and Apple Inc. (e.g., iPhone), and may include a user interface 108 having a display 110 that displays images captured by a camera 111, as is well known. Server 104 may include a search engine 112, a database 114 and an indexer 116. Database 114 may store images, image data, and other data and information associated with a collection of component parts.

The information about the components parts stored in database 114 may include features that may be ascertained visually, or based on the appearance of the part, such as the type, size and/or shape of the part. However, the ascertainment of the visual features need not be performed by a human. Rather, indexer 116 may automatically analyze image data of the parts in order to categorize the part or determine their types. Techniques by which part image data may be automatically analyzed in order to categorize and organize the parts are disclosed in U.S. Patent Pub. No. 20030103673, entitled “Shape searcher”, U.S. Patent Pub. No. 20100076959, entitled “METHODS FOR RETRIEVING SHAPES AND DRAWINGS”, U.S. Patent Pub. No. 20060114252, entitled “Methods for retrieving shapes and drawings”, U.S. Patent Pub. No. 20040249809, entitled “Methods, systems, and data structures for performing searches on three dimensional objects”, and U.S. Patent Pub. No. 20030103089, entitled “Systems and methods for collaborative shape design”, the disclosures of which are incorporated by reference herein in their entireties.

Indexing engine 116 may extract shape signatures from sets of files (e.g., sketches, images, 2D drawings and 3D models) which contain shape representations of parts or objects. Indexer 116 may then organize the files based on the visual family characteristics or rules defined for clustering or grouping of a set of visual attributes (e.g., geometry or shape) based on a similarity threshold. This visual information may then be used during a search. For example, when multiple images (e.g., multiple images of a same object captured by camera 111) are provided as input for a search, search engine 112 may match this shape input data against the visual family to obtain a match and may display a representative part/object from the visual family. Mobile device 102 communicates via internet 106 with server 104, where the indexed information is stored.

During use, a user of mobile device 102 may use camera 111 to capture multiple images of an object that the user would like engine 112 to search for in database 114. The multiple images may be taken from any angles, and do not necessarily have to be at right angles, i.e., do not necessarily have to be at orthogonal angles, relative to each other. All of the captured images of the same object may be entered into search engine 112 as a single search request. The multiple images included as search engine input may include at least two images, and there may be no upper limit on the number of images that may be used as input to a single search request.

If the object is resting on a surface when at least some of the images are captured, then the object may be lifted from the surface while one or more additional images of the object are captured from views that are generally in an upward direction. These additional images may also be used as input into the same search request as the previously captured images, which may have been from downward and/or lateral views.

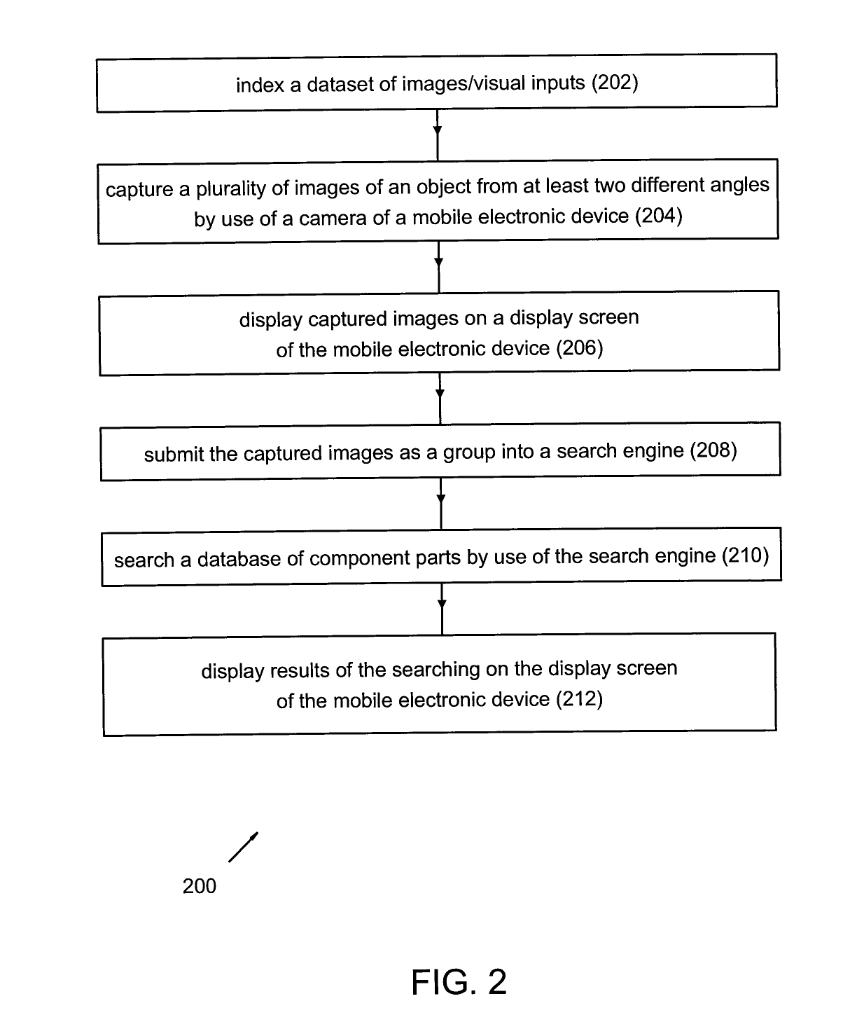

One embodiment of a search method 200 of the present invention is illustrated in FIG. 2. In a first step 202, a dataset of images/visual inputs are indexed. For example, the images/visual input may be indexed in database 114 using indexer 116.

In a second step 204, a plurality of images of an object captured. The capturing is performed by use of a camera of a mobile electronic device. The images are captured from at least two different angles. For example, a user may use camera 111 of mobile device 102 to capture more than one image of an object, which may be a component part (e.g., a screw, a fastener, a plumbing elbow, a flange, etc.). The number of images captured may have no upper limit, but may typically be between ten and thirty in one embodiment. The user may move camera 111 to different viewpoints in order to capture each of the images.

In a third step 206, the captured images are displayed on a display screen of the mobile electronic device. For example, the images captured by camera 111 may be displayed on display screen 110 of user interface 108.

In a fourth step 208, the captured images are submitted as a group into a search engine. That is, each of the captured images may be entered into search engine 112 at the same time as the inputs to a single search of database 114 that may be performed by search engine 112.

In a fifth step 210, the database of component parts may be searched by use of the search engine. A result of the searching may be dependent upon each of the captured images in the submitted group. That is, search engine 112 may take into account each and every one of the images captured by camera 111 when selecting one or more component parts in database 114 that best match the object that is the subject of the captured images.

In a sixth step 212, the results of the searching are displayed on a display screen of the mobile electronic device. For example, the one or more component parts in database 114 that best match the object that is the subject of the captured images may be displayed on display screen 110 of user interface 108.

While this invention has been described as having an exemplary design, the present invention may be further modified within the spirit and scope of this disclosure. This application is therefore intended to cover any variations, uses, or adaptations of the invention using its general principles.

What is claimed is:

1. A method of searching a database of component parts, comprising the steps of:
capturing a plurality of images of an object, the capturing being performed by use of a camera of a mobile electronic device, the images being captured from at least two different angles;
submitting the captured images as a group into a search engine; and
searching the database of component parts by use of the search engine, a result of the searching being dependent upon each of the captured images in the group.

2. The method of claim 1 wherein the plurality of images comprise at least three images.

3. The method of claim 2 wherein no two of the images are captured at a right angle relative to each other.

4. The method of claim 1 wherein the mobile electronic device comprises a personal cellular telephone.

5. The method of claim 1 comprising the further step of displaying each of the captured images on a display screen of the mobile electronic device.

6. The method of claim 5 comprising the further step of displaying results of the search on the display screen of the mobile electronic device.

7. The method of claim 1 wherein the mobile electronic device communicates with the search engine via the Internet.

8. A method of searching a database of component parts, comprising the steps of:
capturing at least three images of an object, the capturing being performed by use of a camera of a mobile electronic device, each of the images being captured from a different respective angle;
submitting the captured images into a search engine; and
searching the database of component parts by use of the search engine, a result of the searching being dependent upon each of the captured images.

9. The method of claim 8 wherein the plurality of images comprise at least seven images.

10. The method of claim 8 wherein no two of the images are captured at a right angle relative to each other.

11. The method of claim 8 wherein the mobile electronic device comprises a personal cellular telephone.

12. The method of claim 8 comprising the further step of displaying each of the captured images on a display screen of the mobile electronic device.

13. The method of claim 12 comprising the further step of displaying results of the search on the display screen of the mobile electronic device.

14. The method of claim 8 wherein the mobile electronic device communicates with the search engine via the Internet.

15. A method of searching a database of component parts, comprising the steps of:
capturing at least seven images of an object, the capturing being performed by use of a camera of a mobile electronic device, each of the images being captured from a different respective angle;
submitting the captured images into a search engine; and
searching the database, by use of the search engine, for a component part best matching the captured images, a result of the searching being dependent upon each of the captured images.

16. The method of claim 15 wherein no two of the images are captured at a right angle relative to each other.

17. The method of claim 15 wherein the mobile electronic device comprises a personal cellular telephone.

18. The method of claim 15 comprising the further step of displaying each of the captured images on a display screen of the mobile electronic device.

19. The method of claim 15 comprising the further step of displaying results of the search on the display screen of the mobile electronic device.

20. The method of claim 15 wherein the mobile electronic device communicates with the search engine via the Internet.
